(19) United States
(12) Patent Application Publication
(10) Pub. No.: US 2026/0080211 A1
(43) Pub. Date: Mar. 19, 2026

(54) Time-Series Optimized Transformer For Observability With Multimodal Input (TOTO-M)

(71) Applicant: Datadog, Inc., New York, NY (US)

(72) Inventors: Benjamin Jacob Cohen, New York, NY (US); Emaad Ali Khwaja, Woodside, NY (US); Viktoriya Zhukova, Paris (FR); Othmane Abou-Amal, New York, NY (US)

(73) Assignee: Datadog, Inc., New York, NY (US)

(21) Appl. No.: 19/249,420

(22) Filed: Jun. 25, 2025

Related U.S. Application Data
(60) Provisional application No. 63/664,217, filed on Jun. 26, 2024.
(60) Provisional application No. 63/694,277, filed on Sep. 13, 2024.

(51) Int. Cl. G06N 3/045

(52) U.S. Cl. CPC G06N 3/045

(57) ABSTRACT

The present disclosure describes technology for training and deploying time-series optimized transformers for observability with multimodal input (TOTO-M). The system includes processors and a storage device for storing instructions. The processors may execute the instructions to process multimodal data using an artificial intelligence (AI) model. The AI model includes a text embedding model configured to generate one or more query text embeddings based one or more query texts corresponding to multivariate time-series data The AI model further includes a patch embedding layer configured to generate patch embeddings from the multivariate time-series data and a transformer architecture comprising one or more segments including space-wise blocks and time-wise blocks. The transformer architecture is configured to receive the patch embeddings combined with the one or more query text embeddings, process the patch embeddings, and output transformed embeddings.

### CROSS-REFERENCE TO RELATED APPLICATIONS

The present application claims the benefit of the filing date of U.S. Provisional Ser. No. 63/694,277 , filed Sep. 13, 2024, and U.S. Provisional Ser. No. 63/664,217 , filed Jun. 26, 2024, the disclosure of which is hereby incorporated herein by reference.

### BACKGROUND

Basic time-series forecasting models, such as autoregressive integrated moving average (ARIMA), exponential smoothing, and general machine learning models, are typically trained for each metric to be forecast. Training for each metric has several limitations, including the need to develop and maintain separate models for each metric and the inability to generalize across different types of metrics. Developing and maintaining separate models for each metric limits scalability, especially when forecasting many types of metrics. Moreover, the inability of these models to generalize across different types of metrics results in poor performance on diverse datasets, even with time-consuming and costly retraining and tuning of the models.

Large neural network-based generative models, often referred to as “foundation models,” have improved upon the basic time-series forecasting models. However, existing foundation models perform poorly when handling time-series data with characteristics such as high cardinality, high time resolution, sparsity, and/or right skew, as well as time-series data with outliers and anomalies. Time-series data having such characteristics may include time-series data of metrics associated with infrastructure data, such as memory usage, CPU load, disk I/O, and network throughput, as well as application performance indicators like hit counts, error rates, and latency.

### BRIEF SUMMARY

The present disclosure describes a forecasting foundation model for generating multivariate probabilistic predictions from the multivariate time-series data provided to the forecasting foundation model. The forecasting foundation model may include a factorized transformer architecture and a probabilistic mixture model head. The factorized transformer architecture may include factorized space-time attention blocks, that allow for efficient grouping of multivariate time-series features, thereby reducing computational overhead while maintaining high accuracy. The probabilistic mixture model head may be a Student-T mixture model head that generates probabilistic predictions from the output of the factorized transformer architecture.

One aspect of the disclosure provides a method for forecasting time-series data. The method may include generating, by one or more processors, one or more query text embeddings based on one or more query texts corresponding to multivariate time-series data; generating, by one or more processors, patch embeddings from the multivariate time-series data; combining, by the one or more processors, the one or more query text embeddings with the patch embeddings; and processing, by the one or more processors, the combined query text embeddings and patch embeddings to generate transformed embeddings.

In some instances, the one or more query text embeddings are generated by a text embedding model executing on the one or more processors. In some examples, the text embedding model is a Bidirectional Encoder Representations from Transformers (BERT) or a general-purpose text embedding model (GTE). In some examples, the processing is performed by a multimodal foundation model executing on the one or more processors.

In some instances, a patch embedding layer generates the patch embeddings by: dividing each variate of the multivariate time-series data along a time dimension to generate patches of data. In some examples, the patches of data are projected linearly into an embedding space having a number of dimensions D. In some examples, the number of dimensions D matches an amount of the one or more query text embeddings.

Another aspect of the disclosure is directed to a system. The system may comprise one or more processors and one or more storage devices storing instructions that, when executed by the one or more processors, cause the one or more processors to process multimodal data using an artificial intelligence (AI) model. The AI model may comprise a text embedding model configured to generate one or more query text embeddings based one or more query texts corresponding to multivariate time-series data; a patch embedding layer configured to generate patch embeddings from the multivariate time-series data; a transformer architecture comprising one or more segments, each segment of the one or more segments including at least one space-wise block and at least one time-wise blocks, the transformer architecture being configured to: receive patch data comprising the patch embeddings combined with the one or more query text embeddings, process the patch embeddings, and output transformed embeddings.

In some instances, the AI model is a decoder-only model.

In some instances, the text embedding model is a Bidirectional Encoder Representations from Transformers (BERT) or a general-purpose text embedding model (GTE).

In some instances, the patch embedding layer generates the patch embeddings by dividing each variate of the multivariate time-series data along a time dimension to generate patches of data. In some examples, the patches of data are projected linearly into an embedding space having a number of dimensions D.

In some examples, the number of dimensions D matches an amount of the one or more query text embeddings.

In some instances, the multivariate time-series data and the query texts are different data types.

Another aspect of the disclosure is directed to a system for forecasting time-series data, the system comprising one or more processors and one or more storage devices storing instructions. The instructions, when executed by the one or more processors, cause the one or more processors to generate one or more query text embeddings based on one or more query texts corresponding to multivariate time-series data; generate patch embeddings from the multivariate time-series data; combine the one or more query text embeddings with the patch embeddings; and process the combined query text embeddings and patch embeddings to generate transformed embeddings.

In some instances, the one or more query text embeddings are generated by a text embedding model executing on the one or more processors. In some examples, the text embedding model is a Bidirectional Encoder Representations from Transformers (BERT) or a general-purpose text embedding model (GTE).

In some instances, the processing is performed by a multimodal foundation model executing on the one or more processors.

In some instances, a patch embedding layer generates the patch embeddings by dividing each variate of the multivariate time-series data along a time dimension to generate patches of data. In some examples, the patches of data are projected linearly into an embedding space having a number of dimensions D, and wherein the number of dimensions D matches an amount of the one or more query text embeddings.

### BRIEF DESCRIPTION OF THE DRAWINGS

FIG. 1 is an example forecasting foundation model for multivariate time-series data, in accordance with aspects of the disclosure.

FIG. 2 is an example illustration of multivariate time-series data, in accordance with aspects of the disclosure.

FIG. 3 is an example illustration of generating patch embeddings from multivariate time-series data, in accordance with aspects of the disclosure.

FIG. 4 is an example factorized space-time transformer architecture, in accordance with aspects of the disclosure.

FIG. 5 is an example probabilistic mixture model head, in accordance with aspects of the disclosure.

FIG. 6 illustrates an example query in accordance with aspects of the disclosure.

FIG. 7 illustrates a multimodal forecasting foundation model according to aspects of the disclosure.

FIG. 8 illustrates an example computing environment for training and deploying foundation models according to aspects of the disclosure.

FIG. 9 is a flow diagram illustrating a method for forecasting time-series data according to aspects of the disclosure.

### DETAILED DESCRIPTION

The present disclosure relates to a forecasting foundation model for multivariate time-series data. The forecasting foundation model, an artificial intelligence (AI) model also referred to herein as a time-series optimized transformer for observability (TOTO), is configured to generate multivariate probabilistic predictions from the multivariate time-series data. The foundation model may include a factorized transformer architecture and a probabilistic mixture model head. The factorized transformer architecture may include multiple segments. Each segment may be factorized, such that each segment includes a mixture of alternating space-wise and time-wise attention blocks. The mixture of alternating space-wise and time-wise attention blocks may be adjustable during training of the forecasting foundation model via one or more hyperparameters of the foundation model to adjust the focus to the temporal or spatial dimensions of the multivariate time-series data as needed.

The probabilistic prediction head may be a Student-T mixture model head configured to generate forecasts from the output of the multi-headed attention layer. The Student-T mixture model uses a mixture of Student-T distributions to capture the uncertainty in time-series forecasting with multivariate time-series data having heavy tails and outliers.

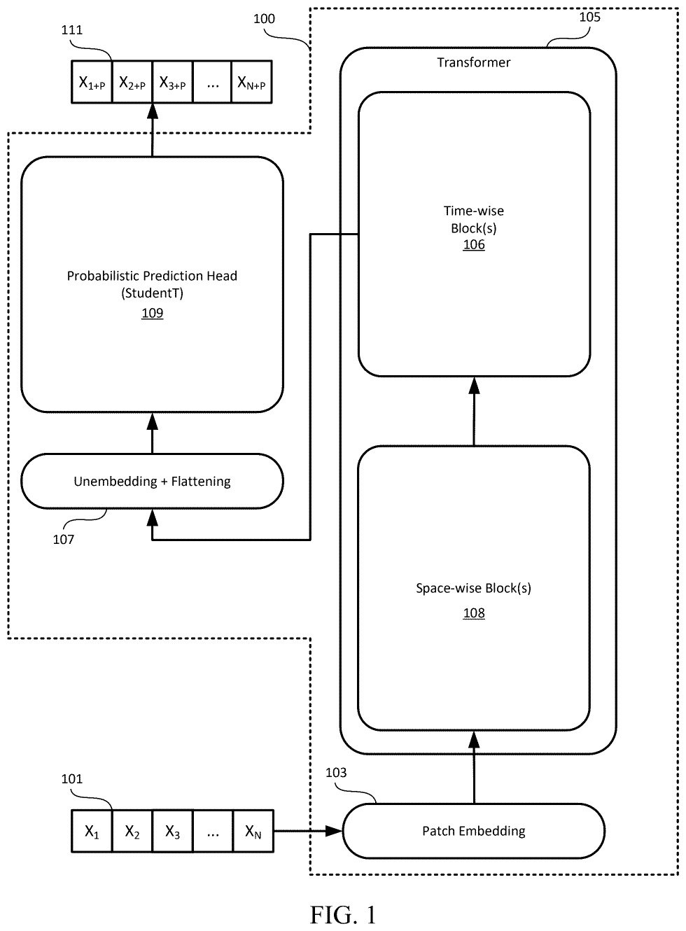

FIG. 1 illustrates an example forecasting foundation model 100. As shown, the forecasting foundation model includes a patch embedding layer 103, a factorized transformer architecture 105 (referred to herein as “transformer 105”), unembedding and flattening layer 107, and a probabilistic prediction head 109. As further illustrated, the transformer 105 includes time-wise block(s) 106 and space-wise blocks(s) 108, which together form segments. The amount, configuration, and ordering of time-wise blocks 106, space-wise blocks 108 and segments may be configured during training of the forecasting foundation model 100, as further described herein. The example forecasting foundation model 100 is shown at inference, also referred to herein as “run time.” As shown, the forecasting foundation model processes multivariate time-series data 101, also referred to herein as “input data,” and generating probabilistic predictions 111, also referred to herein as “output data.”

The multivariate-time-series data includes data for individual variates captured or otherwise determined at various time steps. As further shown in FIG. 1, the input data 101 includes data captured from a first time period “1” (X₁), a second time period “2” (X₂), a third time period “3” (X₃), and additional data captured through time period “N” (X_{N}). The example input data may include time-series data having characteristics such as high cardinality, high time resolution, sparsity, right skew, outliers, and/or anomalies. Examples of such multivariate-time-series data may include metrics associated with infrastructure data, such as memory usage, CPU load, disk I/O, and network throughput, and application performance indicators like hit counts, error rates, and latency.

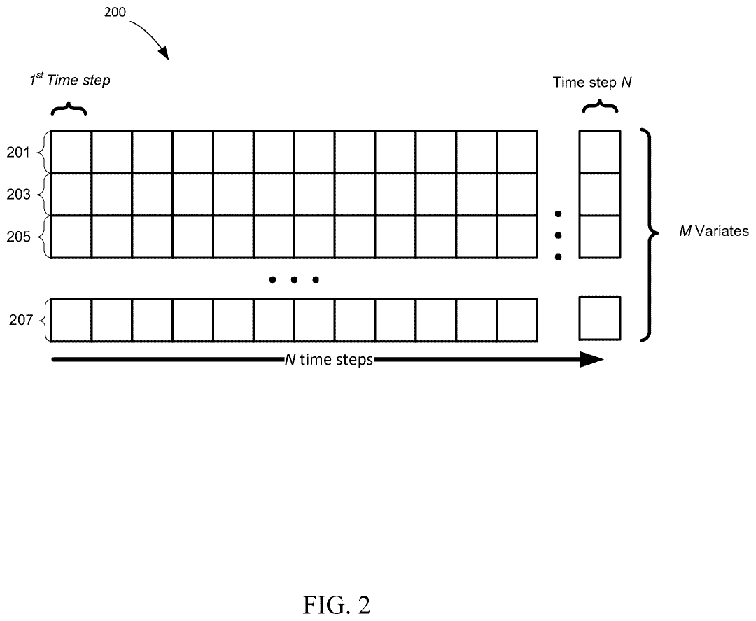

FIG. 2 illustrates a more detailed example set of multivariate time-series data 200. The example set of multivariate time-series data 200 includes data for M variates, where M is a natural number, with the data for each variate being separated into respective rows. In this regard, data for a first variate is included in row 201, data for a second variate is included in row 203, data for a third variate is included in row 205, and data for an M^{th} variate is included in row 207. For clarity, only four variates are illustrated in the example set of multivariate time-series data 200, although any number of variates may be included in a multivariate time-series data set.

As further illustrated in FIG. 2, the data corresponding to each variate is captured or obtained at a first time step through N time steps, where N is a positive integer. The term “first time step” means the time that data is first captured or obtained for a given multivariate time-series data set, not a particular point in time. In this regard, a multivariate time-series data set may have data captured over a long time period. Such a data set may be split into smaller data sets having shorter time periods, with the smaller data sets having a different (or the same) “first time step” of the larger data set. Although FIG. 2 illustrates the data being stored in order from a first time step to the N^{th} time step, the order may be reversed such that the data is stored in order from the N^{th} time step to the first time step.

Data corresponding to each time step is illustrated by a block. Although FIG. 2 illustrates blocks at each time step, some variates may have no data or partial data at certain time steps.

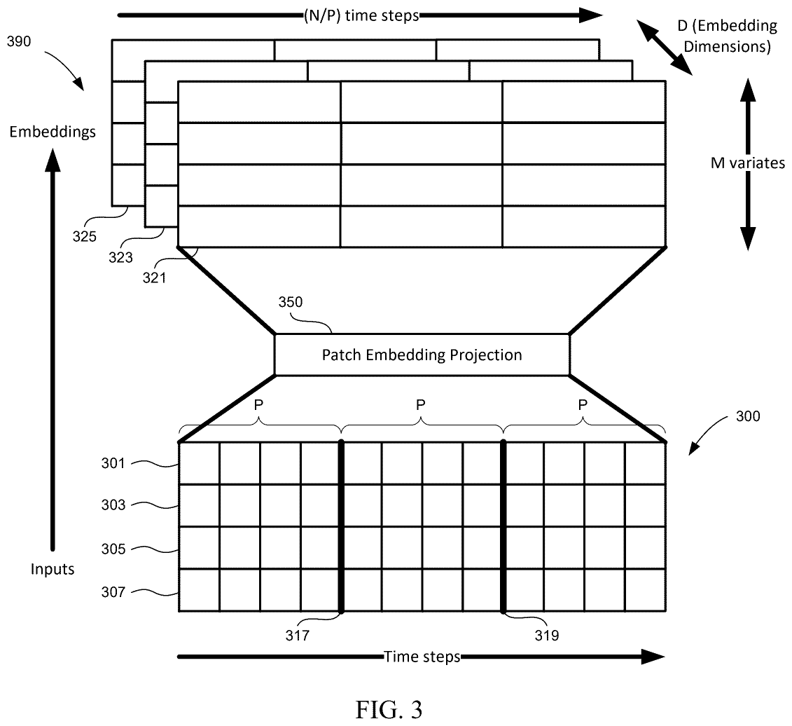

Referring back to FIG. 1, during inference, the patch embedding layer 103 may receive or otherwise retrieve the multivariate time-series data 101. The patch embedding layer 103 may generate patch embeddings. FIG. 3 illustrates a process of a patch embedding layer, such as patch embedding layer 103, generating patch embeddings within an embedding space 390 from multivariate time-series data 300, which may be compared with multivariate time-series data 200. As illustrated, the multivariate time-series data 300 includes data for four variates (301, 303, 305, and 307) captured over twelve (12) time steps.

The patch embedding layer may generate patches of data by dividing each variate along the time dimension into patches of size P, where P may be any number of time steps. In the example illustrated in FIG. 3, P is four, and each variate of the multivariate time-series data 300 is split into three patches of four (4) time steps, with the first patch including the first four blocks of data before line 317, the second patch including the four blocks of data between lines 317 and 319, and the third patch including the last four blocks of data after line 319. The patch embedding layer may generate twelve patches of data across the four variates, with three patches of data being created for each of the four variates.

The patches of data may be projected linearly into an embedding space of dimension D (as illustrated by block 350), thereby creating an output of M×N/P×D patch embeddings, where D is a natural number. With reference to FIG. 3, the embedding space 390 includes three dimensions, 321, 323, and 325. The number of dimensions D may be set as a hyperparameter during training of the forecasting foundation model 100. The number of dimensions D may be selected empirically, such as through observation and trial and error during fine-tuning of the hyperparameters of the forecasting model.

Referring again to FIG. 1, during run time, the patch embeddings generated by the patch embedding layer 103 are output to the transformer 105. The transformer 105 processes the patch embeddings using the space-wise block(s) 108 and time-wise block(s) 106 and generates transformed embeddings, which are in turn sent to the probabilistic prediction head 109.

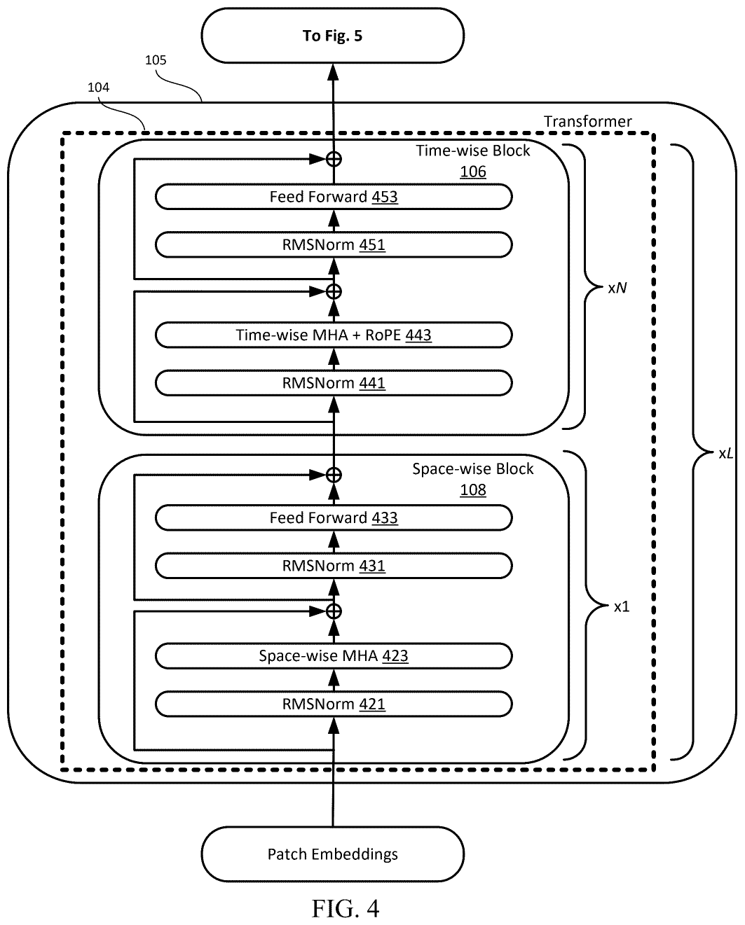

The transformer 105 of the forecasting foundation model 100 is a factorized transformer architecture 105, having a configurable number of time-wise block(s) 106 and space-wise blocks(s) 108, which together form segments. FIG. 4 illustrates a more detailed version of the factorized transformer architecture 105. As shown, the transformer includes L segments of one (1) space-wise block 108 and N time-wise blocks 106, where L and N are each a natural number. A single segment, identified by the dashed box 104, is shown in FIG. 4. The number of time-wise blocks per segment may be set via an adjustable hyperparameter during training of the forecasting foundation model.

For example, the hyperparameter may set a ratio of time-wise blocks to space-wise blocks in each segment. For instance, the ratio may be 2:1, 3:1, 4:1, 12:1, 5:2, etc. In instances where the ratio of time-wise blocks to space-wise blocks requires more than one space-wise block, the number of space-wise blocks may be more than one. Additionally, the ordering of space-wise and time-wise blocks can be configured, e.g. a 2:1 ratio of time-wise to space-wise may be ordered as [time-wise, time-wise, space-wise] or [space-wise, time-wise, time-wise]. In this regard, although FIG. 4 illustrates a single space-wise block 108, the number of space-wise blocks may also be configurable, such as by setting the hyperparameter to a ratio that requires more than one space-wise block. In another example, during training of the forecasting foundation model, separate hyperparameters may be set to define the number of space-wise blocks and time-wise blocks, respectively, in each segment. In yet another example, the number of space-wise blocks and time-wise blocks may be set for each individual segment via hyperparameters, during training, such that each segment can have the same or different configurations of space-wise and time-wise blocks. By adjusting the number of space-wise and/or time-wise blocks, the focus of the forecasting foundation model may be adjusted to devote more computational operations to temporal or spatial interactions within the multivariate time-series data as needed.

The number of segments L within the transformer 105 may also be set via a hyperparameter during training of the forecasting foundation model 100. The number of segments L may be selected empirically, such as through observation and trial and error during fine-tuning of the hyperparameters of the forecasting model. The segments may process data sequentially. For instance, the output of a first segment may form the input of a second segment, the output of the second segment may form the input of a third segment. This process may repeat until the last segment generates a final output.

As explained, the transformer 105 processes the patch embeddings from the patch embedding layer and outputs transformed embeddings. Within the transformer, each space-wise block and time-wise block may contain an attention operation that generates an attention score, intermediate values computed by each respective space-wise and time-wise block. Each space-wise block and time-wise block may use the attention scores to transform the input embeddings and output transformed embeddings, which are subsequently input into other space-wise and/or time-wise blocks as input embeddings. The final block of the transformer may output transformed embeddings.

As further illustrated in FIG. 4, segment 104 of the transformer 105 includes a space-wise block 108 and N time-wise blocks 106. Each block includes an attention layer and a feed forward layer. In this regard, the attention layer of the space-wise block 108 includes a space-wise multi-head attention 423 and the feed forward layer includes feed forward neural network 433. Normalization layers RMSNorm 421 and RMSNorm 431 are positioned before the space-wise multi-head attention 423 and the feed forward neural network 433, respectively. Time-wise blocks 106 each include an attention layer including time-wise multi-head attention with rotary position embedding (RoPE) 443 and a feed forward layer including feed forward neural network 453. Normalization layers RMSNorm 441 and RMSNorm 451 are positioned before the time-wise multi-head attention with RoPE 443 and feed forward neural network 453, respectively.

The attention layers, including the space-wise multi-head attention 423 and time-wise multi-head attention weigh the importance of different parts of the received data. This enables the model to focus on relevant information and capture dependencies across various parts of the input data. RoPE, within the attention layer of the time-wise block 106 may encode position information into the data, which the time-wise multi-head attention may leverage when determining time-wise relationships between data.

The feed forward neural networks 433, 453 may be a Swish-Gated Liner Unit (SwiGLU). In some embodiments, other feed forward neural networks may be used, such other gated linear units (GLUS), e.g., Glu, ReGLU, Gaussian Error Gated Linear Unit (GEGLUE), etc.

RMSNorm is Root Mean Square Normalization, a normalization technique used to normalize the data before processing by an attention layer 423, 443 or feed forward neural network 433, 453. Although the normalization layers 421, 431, 441, and 451 are shown in FIG. 4 as implementing RMSNorm, other normalization techniques may be used, such as LayerNorm, Compressed RMSNorm (CRMSNorm), Batch Normalization (BatchNorm), etc.

The outputs of the normalization layers RMSNorm 421, 431, 441, and 451 are input into space-wise multi-head attention 423, feed forward neural network 433, time-wise multi-head attention with rotary position embedding (RoPE) 443, and feed forward neural network 453, respectively. The operators in FIG. 4 indicate elementwise addition of vectors, typically referred to as “residual ⊕ connections” or “skip connections,” where the output of one of more layers is combined with its inputs. Residual connections are used to provide a “shortcut” for the gradients in backpropagation, to mitigate the vanishing gradient problem. For instance, the outputs (intermediate values) of the attention layers 423, 443 or feed forward layers 433, 453 may each be combined with the output from a previous layer, as further illustrated in FIG. 4.

Referring again to FIG. 1, the transformed embeddings may be unembedded and flattened, as indicated by the unembedding and flattening block 107. The unembedding and flattening block 107 takes the transformed embeddings output by the Transformer 105 and prepares it for the probabilistic prediction head 109. In this regard, the unembedding and flattening block 107 transforms the transformed embeddings which are higher-dimensional and flattens them into a flattened representation that are used to form the parameters for the probabilistic prediction head 109.

The probabilistic prediction head, comprising a Student-T mixture model (SMM) is configured to generate probabilistic predictions for one or more of the variates of the multivariate time-series data from the flattened and unembedded transformed embeddings. In this regard, the SMM generates the probabilistic prediction by assigning a weighting to k Student-T distributions, where k is an integer. The weighting may be determined using a learnable function of the unembedded and flattened transformed embeddings. For example, the transformed embeddings may be projected linearly into a set of logits, such that there is one logit value for each of the k distributions. These logit values may then be normalized into probability scores, also referred to as probabilistic predictions, such as by using a SoftMax function.

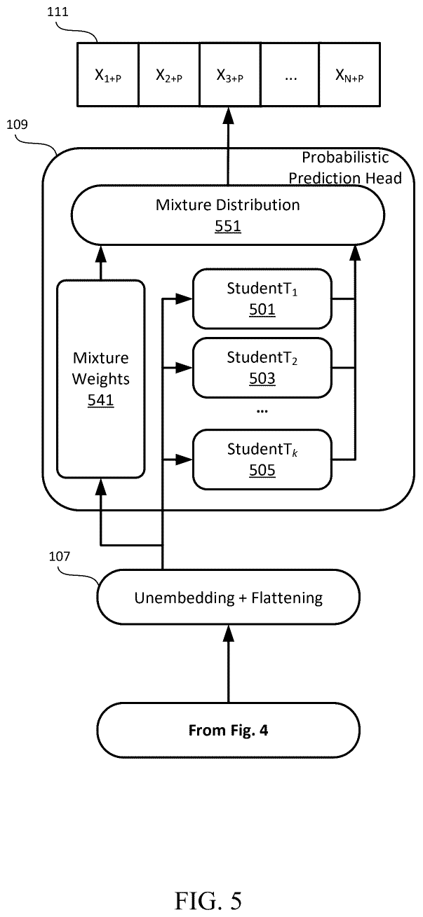

FIG. 5 illustrates a more detailed view of the probabilistic prediction head 109. As shown, the probabilistic prediction head includes an SMM having a mixture weights block 541, a mixture distribution block 551, and k Student-T distributions 501, 503, 505, where k is a positive integer. The value of k may be set via an adjustable hyperparameter during training of the forecasting foundation model 100.

As further illustrated in FIG. 5, the mixture weights block 541 is an input to the mixture distribution block 551. The mixture weights block 541 is configured to provide the learned weighting for each of the individual Student-T distributions 501-505, within the SMM. During inference, the SMM predicts k Student-T distributions for each variate and time step using Student-T distributions 501-505. The k Student-T distributions are predictions may include predictions of a location parameter (k_loc), a scale parameter (k_scale), and a degrees-of-freedom parameter (k_df). As such, for each time step, k loc, k scale, and k df parameters. These parameters may be generated in addition to k logits. The mixture weights block 541 determines the learned weightings for each of these k distributions and provides these learned weightings to the mixture distribution block 551.

The mixture distribution block may take the individual Student-T distributions generated by StudentT₁ 501, StudentT₂ 503, and StudentTₖ 505, along with their respective mixture weights generated by the mixture weights block 541 as inputs. The mixture distribution block may combine these components according to their learned importances (the mixture weights) to form a single, more flexible output likelihood, referred to herein as a mixture distribution. The mixture distribution may be used by the forecasting foundation model 100 to generate the probabilistic predictions 111 for the multivariate time-series data 101. The probabilistic predictions, 111, are the forecasts for the input time-series data, shifted P time steps (the size of a patch of data) into the future.

By using a Student-T mixture model, the forecasting foundation model 100 can generate more accurate probabilistic predictions of complex, real-world multivariate time-series data that may include outliers, heavy tails, extreme skew, and multimodality, than a single distribution. To produce forecasts of variable lengths, the Student-T mixture model outputs may be sampled, and then the samples may be passed back into the model. This operation of sampling outputs of a model and passing the samples back into the model is sometimes referred to as “autoregressive decoding. ” Alternatively, the mean of the Student T mixture model may be determined. The mean may then be passed back into the model as the input at the next decoding step. The number of outputs sampled and input back into the model typically equates to the accuracy of the probabilistic forecast with inference costs. In this regard, more samples input back into the model typically provides a more accurate model but at the expense of slower processing, whereas few samples input back into the model typically provides a less accurate model but with faster processing.

The forecasting foundation model may be trained using various machine learning paradigms, including supervised, unsupervised, semi-supervised, and reinforcement learning. For instance, the training process of the forecasting foundation model may involve providing the model with numerous training examples as input. Each training example may be accompanied by a “ground-truth” label, which represents the desired output for the model when processing that specific example. For time-series forecasting, the ground-truth label may be the future value of the same time-series. The model's generated output may then be compared to this ground-truth label using a loss function, which quantifies the error or discrepancy between them. This calculated error is subsequently backpropagated through the model, enabling the adjustment of the model's internal weights to minimize future errors. For instance, and since the forecasting foundation model 100 performs a regression task to predict multivariate time-series values, a mean squared error (MSE) function, mean absolute error (MAE) function, or other such function may be used to evaluate the discrepancy between determined probabilistic predictions and the actual future values. In some instances, the loss function may be a negative log likelihood (NLL) of the ground truth with respect to the predicted SMM. The gradient of this error with respect to the model's weights may be computed using an algorithm like backpropagation, and these weights are then updated. This iterative process of forward pass, error calculation, backpropagation, and weight adjustment may continue until predefined stopping criteria are satisfied. These criteria might include a set number of training iterations, a maximum training duration, convergence of the model's performance, or achieving a minimum accuracy threshold.

Such training of the forecasting foundation model can be implemented using third-party, commercial or open source machine learning frameworks. Such commercial machine learning frameworks offer platforms for constructing and training neural networks, providing capabilities for defining model architectures (including setting hyperparameters such as those discussed herein), automatic differentiation, optimizers to handle weight updates, and utilities for efficient data loading and preprocessing, while supporting GPU acceleration for expedited training of computationally intensive models.

The forecasting foundation model 100 can be pretrained such that training of the forecasting foundation model may occur during a training phase. In this regard, the pretrained forecasting foundation model, and its parameters (e.g., hyperparameters, weightings, etc.), are set during the training phase. The pretrained forecasting foundation model may then be used for runtime inference without any additional training being required. Moreover, the pretrained model may not be trained during runtime inference, such that all parameters of the pretrained forecasting foundation model remain unchanged during runtime inference. In addition to the hyperparameters described herein, additional hyperparameters such as multilayer perceptron (MLP) dimensions, number of heads for multi-headed attention layers, number of variates, decay rates, weight decay, space wise layer cadence, patch size, the number of student-T mixture model distributions, initial learning rate, annealing schedule, batch size, warmup steps, total training steps, etc., may be set during training.

### Cold Start

When insufficient time-series data is available to adequately train forecasting models, the forecasting models may generate inaccurate forecasts. Similarly, when insufficient time-series data is input into pretrained forecasting models for processing, the pretrained forecasting model may output inaccurate forecasts. Insufficient time-series data is often generated from ephemeral and/or dynamically scaling infrastructure and sources (e.g., hardware, software, etc.) The issues with training on or processing insufficient time-series data are sometimes referred to as the “cold start problem.”

To address the cold start problem, the forecasting foundation model may be adapted to incorporate query text embeddings as contextual inputs to enhance time-series forecasts. In this regard, the forecasting foundation model may be multimodal, accepting query text embeddings and time-series data. By training the foundation forecasting model on query text embeddings paired with corresponding time-series data, which may or may not be multivariate time-series data, the foundation forecasting model may generate improved forecasts, particularly in “cold-start” situations where limited historical time-series data is available. The adapted forecasting foundation model is referred to herein as a multimodal forecasting foundation model.

The query text embeddings may be generated from query strings containing various information about the particular variate(s) of the time-series data. Such query strings may include information such as what type of software or hardware is being monitored, which time and space aggregation functions are applied, which contexts are included or excluded, etc.

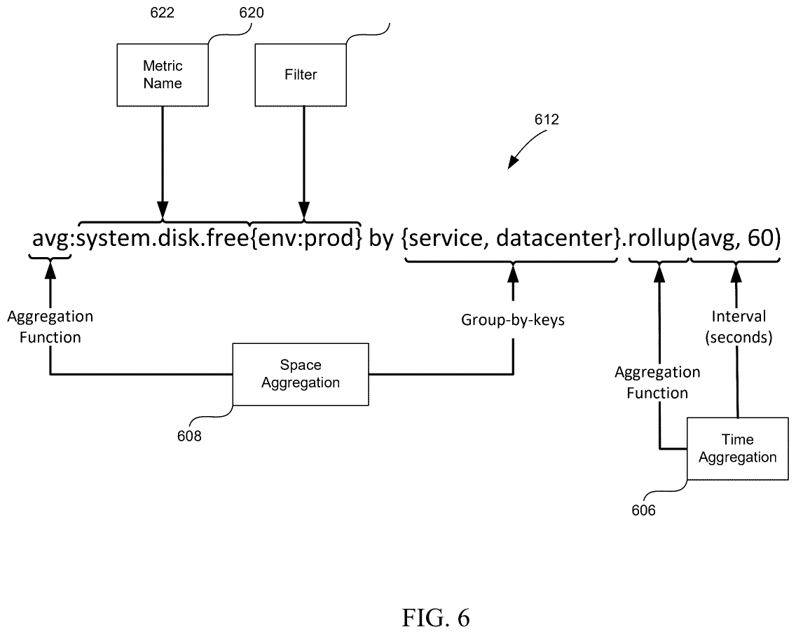

FIG. 6 illustrates an example query text 612. As shown, the query text 612 includes a metric name 620, filter 622, space aggregation 608, and time aggregation 606. The metric name 620 determines the metric that is being queried. In the example query text 612, the metric name is “system. disk. free. ” The filter 622 limits the contexts that are being queried. In the query text 612 shown in FIG. 6, the query is restricted to a production environment (env:prod). The space aggregation 608 indicates that the metric value should be returned for each unique combination of the group-by keys and values, summed across all spatial dimensions. The time aggregation 606 indicates that metric values should be rolled up (aggregation function=“rollup”) to the average for each 60-second interval (Interval(seconds) =avg, 60.)

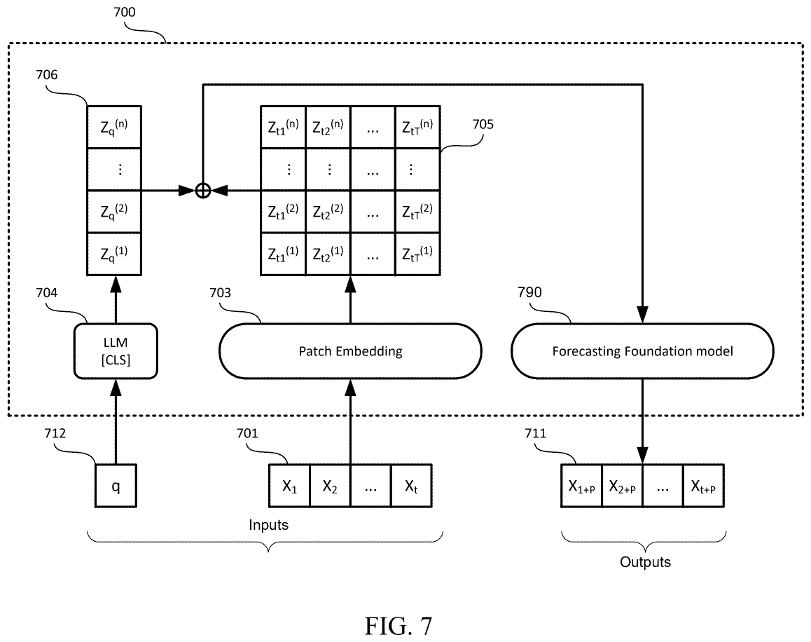

FIG. 7 illustrates an example multimodal forecasting foundation model 700, also referred to herein as a time-series optimized transformer for observability with multimodal input (TOTO-M). As shown, the multimodal forecasting foundation model includes an LLM 704, patch embedding layer 703, and forecasting foundation model 790. The LLM 704 may be configured to represent text within a query, such as query q 712, as embeddings. The LLM 704 may be a Bidirectional Encoder Representations from Transformers (BERT), a general-purpose text embedding model (GTE), or other such models configured to generate embeddings.

The patch embedding layer 703, which may be compared to patch embedding layer 103 of FIG. 1, may be configured to generate patch embeddings 705 for multivariate time-series data, such as input data 701. The forecasting foundation model 790 may be compared with forecasting foundation model 100. The patch embedding size D of the forecasting foundation model 790 may be set, during training, to match that of the LLM 704. In instances where the patch embedding size D of the foundation model 790 does not match the embedding size of the LLM 704, a linear projection may be used to cast the LLM embeddings to the patch embedding size D of the forecasting model 790. As shown in FIG. 7, the embedding size of the LLM 704 is n.

In operation, the LLM 704 may receive a query q 712, which may be compared to query 612. The LLM 704 may generate query text embeddings 706 from the query. The token embeddings may be, for example, a classification token ([CLS] token) generated by a BERT model, or another embedding which is an average embedding value of a query text. The [CLS] token denotes the beginning of a sequence, such as a query text, and its corresponding output embedding may be used as the summary representation of the entire sequence. The values of Z in FIG. 7 are the individual dimensions of the embedding vector.

In an alternative approach to using a [CLS] token, the entire text of the query can be tokenized and a new embedding vector may be generated. The new embedding vector may be the pointwise average of the embedding vectors of each of the input tokens. In the alternative approach, the input string may be tokenized into a sequence of tokens S. For each token sᵢ in S, an embedding may be obtained from a BERT model. The obtained embedding may be represented as Zᵢ, where i goes from 1 to the length of S. The obtained embedding Zᵢ may be a vector of real values Zᵢⱼ, where j goes from 1 to the embedding dimension D. To get the average embedding, each Zⱼ may be averaged across the i dimension.

As further shown in FIG. 7, each query text embedding may be concatenated (or otherwise combined) with corresponding patch embedding data 705 and be provided to the forecasting foundation model 790, which outputs probabilistic predictions 711. The forecasting foundation model 790 will primarily process the context information contained in the query text embeddings using the time-wise blocks, as the network is mostly composed of time-wise blocks. However, the context information contained in the query text embeddings will also be processed by the space-wise blocks. By incorporating the query text embeddings as a secondary modality into the forecasting foundation model 790, the contextual information contained in the query text may be leveraged to improve forecasting accuracy.

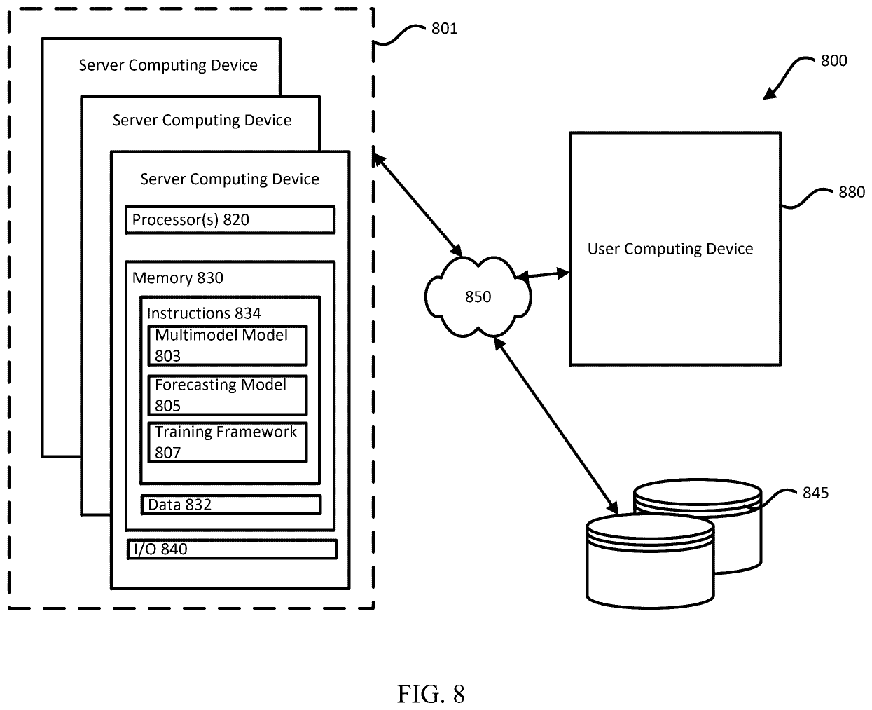

FIG. 8 depicts a block diagram of an example environment 800 for training a foundational forecasting model, such as foundational forecasting model 100 and/or multimodal forecasting foundation model 700. Environment 800 may also be used to process multivariate time-series data using foundational forecasting models and multimodal forecasting foundation models. Training and processing may be implemented on one or more devices having one or more processors in one or more locations, such as in server computing device 801. Client computing device 880 and the server computing device 801 can be communicatively coupled to one or more storage devices 845 over a network 850. The storage devices 845 can be a combination of volatile and non-volatile memory and can be at the same or different physical locations than the computing devices. For example, the storage devices 845 can include any type of non-transitory computer readable medium capable of storing information, such as a hard-drive, solid state drive, tape drive, optical storage, memory card, ROM, RAM, DVD, CD-ROM, write-capable, and read-only memories.

The server computing device 801 can include one or more processors 820, memory 830, and input/output 840. The memory 830 can store information accessible by the processors 820, including instructions 834 that can be executed by the processors 820. The memory 830 can also include data 832 that can be retrieved, manipulated, or stored by the processors 820. The memory 830 can be a type of non-transitory computer readable medium capable of storing information accessible by the processors, such as volatile and non-volatile memory. The processors can include one or more central processing units (CPUs), graphic processing units (GPUs), field-programmable gate arrays (FPGAs), and/or application-specific integrated circuits (ASICs). According to some examples, the data 832 and instructions 834 can include multimodal forecasting models 803, which can be compared to multimodal forecasting foundation model 700, foundational forecasting models 805, which can be compared to foundational forecasting model 100, and training frameworks 807 for training foundational forecasting models and multimodal forecasting models. Such models and frameworks can be installed or downloaded from a communication network.

The instructions 834 can include one or more instructions that, when executed by the processors 820, cause the one or more processors 820 to perform actions defined by the instructions 834. The instructions 834 can be stored in object code format for direct processing by the processors 820, or in other formats including interpretable scripts or collections of independent source code modules that are interpreted on demand or compiled in advance. The instructions 834 can include instructions for processing multivariate time-series data using multimodal forecasting models and foundational forecasting models, as described herein. The models 803, 805 and training framework can be executed using the processors 820, and/or using other processors remotely located from the server computing device 801.

The data 832 can be retrieved, stored, or modified by the processors 820 in accordance with the instructions 834. The data 832 can be stored in computer registers, in a relational or non-relational database as a table having a plurality of different fields and records, or as JSON, YAML, proto, or XML documents. The data 832 can also be formatted in a computer-readable format such as, but not limited to, binary values, ASCII, or Unicode. Moreover, the data 832 can include information sufficient to identify relevant information, such as numbers, descriptive text, proprietary codes, pointers, references to data stored in other memories, including other network locations, or information that is used by a function to calculate relevant data.

The client computing device 880 can also be configured similarly to the server computing device 801, with one or more processors, memory, instructions, and data. The client computing device 880 can also include a user input and a user output. The user input can include any appropriate mechanism or technique for receiving input from a user, such as keyboard, mouse, mechanical actuators, soft actuators, touchscreens, microphones, and sensors.

The server computing device 801 can be configured to transmit data to the client computing device 880, and the client computing device 880 can be configured to display at least a portion of the received data on a display implemented as part of the user output. The user output can also be used for displaying an interface between the client computing device and the server computing device. The user output can alternatively or additionally include one or more speakers, transducers or other audio outputs, a haptic interface or other tactile feedback that provides non-visual and non-audible information to the platform user of the client computing device.

Although FIG. 8 illustrates the processors and the memories as being within the computing devices, components described herein can include multiple processors and memories that can operate in different physical locations and not within the same computing device. For example, some of the instructions and the data can be stored on a removable SD card and others within a read-only computer chip. Some or all of the instructions and data can be stored in a location physically remote from, yet still accessible by, the processors. Similarly, the processors can include a collection of processors that can perform concurrent and/or sequential operation. The computing devices can each include one or more internal clocks providing timing information, which can be used for time measurement for operations and programs run by the computing devices.

The server computing device can be connected over the network to a data center housing any number of hardware accelerators. The data center can be one of multiple data centers or other facilities in which various types of computing devices, such as hardware accelerators, are located. Computing resources housed in the data center can be specified for deploying and/or training models 803, 807.

The server computing device can be configured to receive requests to process data from the client computing device on computing resources in the data center. For example, the environment can be part of a computing platform configured to provide a variety of services to users, through various user interfaces and/or application programming interfaces (APIs) exposing the platform services. The client computing device can transmit input data associated with execution of software. For example, the input can include components of the software. The components can include one or more functions utilizing one or more libraries, and logging information for the one or more functions. The models 803, 805 and training frameworks can receive the input data, and in response, generate outputs and train models, respectively.

As other examples of potential services provided by a platform implementing the environment, the server computing device can maintain a variety of models in accordance with different constraints available at the data center. For example, the server computing device can maintain different families for deploying models on various types of TPUs and/or GPUs housed in the data center or otherwise available for processing.

The devices and the data center can be capable of direct and indirect communication over the network. For example, using a network socket, the client computing device can connect to a service operating in the data center through an Internet protocol. The devices can set up listening sockets that may accept an initiating connection for sending and receiving information. The network itself can include various configurations and protocols including the Internet, World Wide Web, intranets, virtual private networks, wide area networks, local networks, and private networks using communication protocols proprietary to one or more companies. The network can support a variety of short-and long-range connections. The short-and long-range connections may be made over different bandwidths, such as 2.402 GHz to 2.480 GHz, commonly associated with the Bluetooth® standard, 2.4 GHz and 5 GHz, commonly associated with the Wi-Fi® communication protocol; or with a variety of communication standards, such as the LTE® standard for wireless broadband communication. The network, in addition or alternatively, can also support wired connections between the devices and the data center, including over various types of Ethernet connection.

Although three server computing devices, a single client computing device, and single datacenter are shown in FIG. 8, it is understood that the aspects of the disclosure can be implemented according to a variety of different configurations and quantities of computing devices, including in paradigms for sequential or parallel processing, or over a distributed network of multiple devices. In some implementations, aspects of the disclosure can be performed on a single device connected to hardware accelerators configured for processing optimization models, and any combination thereof.

Although FIG. 8 functionally illustrates the processor, memory, and other elements as being within the same block, the processor, computer, computing device, or memory can actually comprise multiple processors, computers, computing devices, or memories that may or may not be stored within the same physical housing. Accordingly, references to a processor, computer, computing device, or memory will be understood to include references to a collection of processors, computers, computing devices, or memories that may or may not operate in parallel. Yet further, although some functions described below are indicated as taking place on a single computing device having a single processor, various aspects of the subject matter described herein can be implemented by a plurality of computing devices, for example, in the “cloud.” Similarly, memory components at different locations may store different portions of instructions 834 and collectively form a medium for storing the instructions. Various operations described herein as being performed by a computing device may be performed by a virtual machine. By way of example, instructions 834 may be specific to a first type of server, but the relevant operations may be performed by a second type of server running a hypervisor that emulates the first type of server. The operations may also be performed by a container, e.g., a computing environment that does not rely on an operating system tied to specific types of hardware.

In addition to the systems described above, methods executed by such systems are described below. While operations of each method are described in a particular order, it should be understood that operations may be performed in a different order and/or some operations may be performed simultaneously or in parallel. Moreover, operations can be added or omitted.

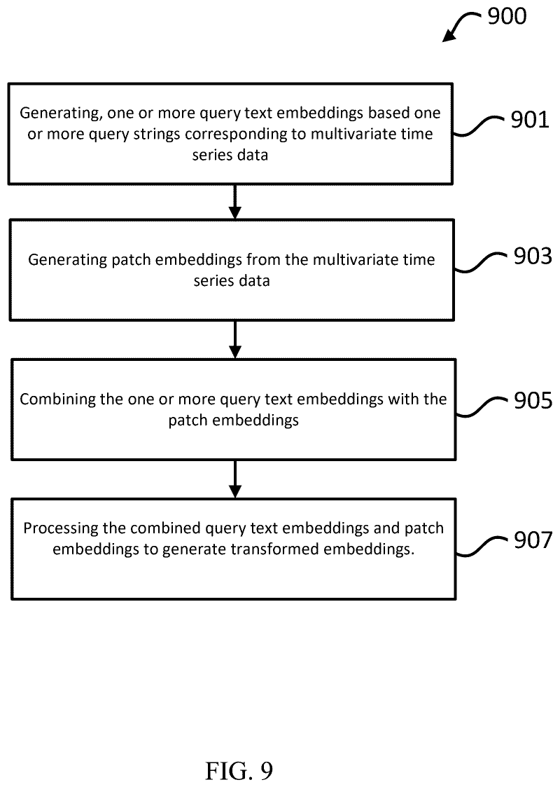

FIG. 9 illustrates an example method 900 of generating transformed embeddings based on multivariate time-series data and a query. In block 901, one or more query text embeddings are generated based on one or more query texts corresponding to multivariate time-series data. The query text embeddings may be generated by an LLM, such as LLM 704, as described herein.

In block 903, patch embeddings are generated from the multivariate time-series data. The patch embeddings may be generated by a patch embedding layer, such as patch embedding layer 703, as described herein.

In block 905, the query text embeddings and the patch embeddings may be combined. Combining the query text embeddings and the patch embeddings may include concatenating the query text embeddings and the patch embeddings, as described herein.

In block 907, the combined query text embeddings and patch embeddings may be processed to generate transformed embeddings. The processing of the embeddings may be performed by a multimodal forecasting foundation model, such as multimodal forecasting foundation model 790.

Aspects of this disclosure can be implemented in digital electronic circuitry, in tangibly-embodied computer software or firmware, and/or in computer hardware, such as the structure disclosed herein, their structural equivalents, or combinations thereof. Aspects of this disclosure can further be implemented as one or more computer programs, such as one or more modules of computer program instructions encoded on a tangible non-transitory computer storage medium for execution by, or to control the operation of, one or more data processing apparatus. The computer storage medium can be a machine-readable storage device, a machine-readable storage substrate, a random or serial access memory device, or combinations thereof. The computer program instructions can be encoded on an artificially generated propagated signal, such as a machine-generated electrical, optical, or electromagnetic signal, that is generated to encode information for transmission to suitable receiver apparatus for execution by a data processing apparatus.

The term “configured” is used herein in connection with systems and computer program components. For a system of one or more computers to be configured to perform particular operations or actions means that the system has installed on it software, firmware, hardware, or a combination thereof that cause the system to perform the operations or actions. For one or more computer programs to be configured to perform particular operations or actions means that the one or more programs include instructions that, when executed by one or more data processing apparatus, cause the apparatus to perform the operations or actions.

The term “data processing apparatus” refers to data processing hardware and encompasses various apparatus, devices, and machines for processing data, including programmable processors, a computer, or combinations thereof. The data processing apparatus can include special purpose logic circuitry, such as a field programmable gate array (FPGA) or an application specific integrated circuit (ASIC). The data processing apparatus can include code that creates an execution environment for computer programs, such as code that constitutes processor firmware, a protocol stack, a database management system, an operating system, or combinations thereof.

The data processing apparatus can include special-purpose hardware accelerator units for implementing machine learning models to process common and compute-intensive parts of machine learning training or production, such as inference or workloads. Machine learning models can be implemented and deployed using one or more machine learning frameworks, such as static or dynamic computational graph frameworks.

The term “program” refers to a computer program, software, a software application, an app, a module, a software module, a script, or code. The computer program can be written in any form of programming language, including compiled, interpreted, declarative, or procedural languages, or combinations thereof. The computer program can be deployed in any form, including as a stand alone program or as a module, component, subroutine, or other unit suitable for use in a computing environment. The computer program can correspond to a file in a file system and can be stored in a portion of a file that holds other programs or data, such as one or more scripts stored in a markup language document, in a single file dedicated to the program in question, or in multiple coordinated files, such as files that store one or more modules, sub programs, or portions of code. The computer program can be executed on one computer or on multiple computers that are located at one site or distributed across multiple sites and interconnected by a data communication network.

The term “database” refers to any collection of data. The data can be unstructured or structured in any manner. The data can be stored on one or more storage devices in one or more locations. For example, an index database can include multiple collections of data, each of which may be organized and accessed differently.

The term “engine” refers to a software-based system, subsystem, or process that is programmed to perform one or more specific functions. The engine can be implemented as one or more software modules or components, or can be installed on one or more computers in one or more locations. A particular engine can have one or more computers dedicated thereto, or multiple engines can be installed and running on the same computer or computers.

The processes and logic flows described herein can be performed by one or more computers executing one or more computer programs to perform functions by operating on input data and generating output data. The processes and logic flows can also be performed by special purpose logic circuitry, or by a combination of special purpose logic circuitry and one or more computers.

A computer or special purpose logic circuitry executing the one or more computer programs can include a central processing unit, including general or special purpose microprocessors, for performing or executing instructions and one or more memory devices for storing the instructions and data. The central processing unit can receive instructions and data from the one or more memory devices, such as read only memory, random access memory, or combinations thereof, and can perform or execute the instructions. The computer or special purpose logic circuitry can also include, or be operatively coupled to, one or more storage devices for storing data, such as magnetic, magneto optical disks, or optical disks, for receiving data from or transferring data to. The computer or special purpose logic circuitry can be embedded in another device, such as a mobile phone, a personal digital assistant (PDA), a mobile audio or video player, a game console, a Global Positioning System (GPS), or a portable storage device, e.g., a universal serial bus (USB) flash drive, as examples.

Computer readable media suitable for storing the one or more computer programs can include any form of volatile or non-volatile memory, media, or memory devices. Examples include semiconductor memory devices, e.g., EPROM, EEPROM, or flash memory devices, magnetic disks, e.g., internal hard disks or removable disks, magneto optical disks, CD-ROM disks, DVD-ROM disks, or combinations thereof.

Aspects of the disclosure can be implemented in a computing system that includes a back end component, e.g., as a data server, a middleware component, e.g., an application server, or a front-end component, e.g., a client computer having a graphical user interface, a web browser, or an app, or any combination thereof. The components of the system can be interconnected by any form or medium of digital data communication, such as a communication network. Examples of communication networks include a local area network (LAN) and a wide area network (WAN), e.g., the Internet.

The computing system can include clients and servers. A client and server can be remote from each other and interact through a communication network. The relationship of client and server arises by virtue of the computer programs running on the respective computers and having a client-server relationship to each other. For example, a server can transmit data, e.g., an HTML page, to a client device, e.g., for purposes of displaying data to and receiving user input from a user interacting with the client device. Data generated at the client device, e.g., a result of the user interaction, can be received at the server from the client device.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A method for forecasting time-series data, the method comprising:
generating, by one or more processors, one or more query text embeddings based on one or more query texts corresponding to multivariate time-series data;
generating, by one or more processors, patch embeddings from the multivariate time-series data;
combining, by the one or more processors, the one or more query text embeddings with the patch embeddings; and
processing, by the one or more processors, the combined query text embeddings and patch embeddings to generate transformed embeddings.

2. The method of claim 1, wherein the one or more query text embeddings are generated by a text embedding model executing on the one or more processors.

3. The method of claim 2, wherein the text embedding model is a Bidirectional Encoder Representations from Transformers (BERT) or a general-purpose text embedding model (GTE).

4. The method of claim 2, wherein the processing is performed by a multimodal foundation model executing on the one or more processors.

5. The method of claim 1, wherein a patch embedding layer generates the patch embeddings by:
dividing each variate of the multivariate time-series data along a time dimension to generate patches of data.

6. The method of claim 5, wherein the patches of data are projected linearly into an embedding space having a number of dimensions D.

7. The method of claim 6, wherein the number of dimensions D matches an amount of the one or more query text embeddings.

8. A system comprising:
one or more processors; and
one or more storage devices storing instructions that, when executed by the one or more processors, cause the one or more processors to process multimodal data using an artificial intelligence (AI) model, the AI model comprising:
a text embedding model configured to generate one or more query text embeddings based one or more query texts corresponding to multivariate time-series data;
a patch embedding layer configured to generate patch embeddings from the multivariate time-series data; and
a transformer architecture comprising one or more segments, each segment of the one or more segments including at least one space-wise block and at least one time-wise blocks, the transformer architecture being configured to:
receive patch data comprising the patch embeddings combined with the one or more query text embeddings,
process the patch embeddings, and
output transformed embeddings.

9. The system of claim 8, wherein the AI model is a decoder-only model.

10. The system of claim 8, wherein the text embedding model is a Bidirectional Encoder Representations from Transformers (BERT) or a general-purpose text embedding model (GTE).

11. The system of claim 8, wherein the patch embedding layer generates the patch embeddings by:
dividing each variate of the multivariate time-series data along a time dimension to generate patches of data.

12. The system of claim 11, wherein the patches of data are projected linearly into an embedding space having a number of dimensions D.

13. The system of claim 12, wherein the number of dimensions D matches an amount of the one or more query text embeddings.

14. The system of claim 8, wherein the multivariate time-series data and the query texts are different data types.

15. A system for forecasting time-series data, the system comprising:
one or more processors; and
one or more storage devices storing instructions that, when executed by the one or more processors, cause the one or more processors to:
generate one or more query text embeddings based on one or more query texts corresponding to multivariate time-series data;
generate patch embeddings from the multivariate time-series data;
combine the one or more query text embeddings with the patch embeddings; and
process the combined query text embeddings and patch embeddings to generate transformed embeddings.

16. The system of claim 15, wherein the one or more query text embeddings are generated by a text embedding model executing on the one or more processors.

17. The system of claim 16, wherein the text embedding model is a Bidirectional Encoder Representations from Transformers (BERT) or a general-purpose text embedding model (GTE).

18. The system of claim 15, wherein the processing is performed by a multimodal foundation model executing on the one or more processors.

19. The system of claim 15, wherein a patch embedding layer generates the patch embeddings by:
dividing each variate of the multivariate time-series data along a time dimension to generate patches of data.

20. The system of claim 19, wherein the patches of data are projected linearly into an embedding space having a number of dimensions D, and wherein the number of dimensions D matches an amount of the one or more query text embeddings.
